(19) United States
(12) Patent Application Publication
(10) Pub. No.: US 2024/0346108 A1
(43) Pub. Date: Oct. 17, 2024

(54) SYSTEM AND METHOD OF PERFORMING CONVOLUTION EFFICIENTLY ADAPTING WINOGRAD ALGORITHM

(71) Applicant: Imagination Technologies Limited, Kings Langley (GB)

(72) Inventors: Ferdinando Insalata, Hertfordshire (GB); Cagatay Dikici, Hertfordshire (GB); James Imber, Hertfordshire (GB); Ivaxi Sheth, Hertfordshire (GB)

(21) Appl. No.: 18/613,443

(22) Filed: Mar. 22, 2024

(30) Foreign Application Priority Data
Mar. 23, 2023 (GB) 2304215.3

(51) Int. Cl. G06F 17/15

(52) U.S. Cl. CPC G06F 17/153

(57) ABSTRACT

Systems and methods of performing convolution efficiently adapting the Winograd algorithm are provided. Methods of convolving an input tensor with weights w use hardware comprising a plurality of linear operation engines as part of performing adaptations of a Winograd algorithm, the Winograd algorithm splitting each input channel i of a total of Cᵢₙ input channels into one or more tiles dᵢ and calculating a result A[Σᵢ₌₁^{Cin}(GwⱼᵢG^{T})∘(B^{T}dᵢB)]A^{T} for each output channel j, wherein G, B and A are constant matrices. The methods comprise determining a first filter F₁ from matrix B wherein the filter F₁ comprises n kernels, each kernel being an outer product of two columns of the matrix B; and using the linear operation engines to perform a convolution of the input tensor with the first filter F₁.

### CROSS-REFERENCE TO RELATED APPLICATIONS AND CLAIM OF PRIORITY

This application claims foreign priority under 35 U.S.C. 119 from United Kingdom patent application No. GB2304215.3 filed on 23 Mar. 2023, the contents of which are incorporated by reference herein in their entirety.

### BACKGROUND

Fast neural network inference is important in many applications, particularly in real-time or near real-time scenarios. In certain applications, such as autonomous vehicles, low latency is safety-critical because it reduces the reaction time of the system. Since convolution accounts for the majority of computation in many Neural Networks, improvements in the efficiency of convolution operations can significantly reduce the inference time.

A Neural Network (NN) is a network comprising a plurality of linked layers that enable the NN to perform various tasks, for example for signal or image processing (including, for example, image classification, image segmentation, and optical character recognition), action recognition, semantic segmentation, style transfer, etc. Each layer receives input data from one or more previous layers or inputs of the NN (e.g. an image), processes the input data in accordance with the operation(s) it performs in order to produce output data, which is provided to one or more next layers as input data and/or is output as one or more outputs of the NN. Data internal to the network that is output from one layer and consumed by another may be referred to as “intermediate data”. In general, data is represented using multidimensional arrays referred to as “tensors”.

A neural network operation is defined herein as an operation that is used to implement all or a part of a neural network layer. A neural network layer may be implemented by one or more neural network operations. Each layer of a NN may perform one or more of a plurality of different neural network operations. Example operations include, but are not limited to convolution, activation, normalisation, pooling and convolution transpose. It will be evident to a person of skill in the art that these are example NN operations, and that this is not an exhaustive list. The layer may be referred to in terms of an operation it performs. For example, a convolution layer is a NN layer that performs a convolution operation. The data input to a NN comprising a convolution layer may comprise text data, audio data, image data (including video data), volumetric data (for example point cloud data) or multimodal data (for example text data with image data, such as captions associated with images).

For a convolution layer the input data is processed by convolving the input data with weights associated with that layer. Specifically, as shown in FIG. 1A, the input data to a convolution layer is typically arranged as a tensor of p planes of input elements, where each plane has dimensions [h,b]. Each plane may be referred to as an input channel to the convolution. A convolution layer is associated with a trainable weight tensor, for example of shape [v, u, p, o] where o is the number of output channels, p is the number of input channels, and v and u are the kernel height and width respectively. This weight tensor may be considered to comprise o “filters” of shape [v, u, p], each of which yields an output channel when convolved with the input data. The convolution is achieved by applying each filter to the input tensor at locations over the “spatial” h and b axes at regular intervals t and s respectively, as illustrated in FIG. 1A. The size of the intervals in a particular axis is referred to as the “stride” over that axis. At each application of the filter, the dot product of the input elements at that location with the filter weights is calculated to produce an output element. Each filter thus produces an output plane (also “output channel” or “activation map”). For example, a convolution layer with 12 filters will produce an output comprising 12 planes. In general, the input data is represented with a 4-dimensional tensor of shape [B, h, b, p], where B is the batch size. The same operation is applied independently to all members of the batch according to the above description. The principles described herein will be understood to apply equally to input tensors with any batch size.

Generally, a convolution operation produces an output tensor that is smaller, in the h and/or b direction, relative to the input tensor. For example, a 4×4 input tensor convolved with a 3×3 filter with a stride of 1 in the x and y directions will produce a 2×2 output tensor.

A convolution operation can typically be represented as a matrix multiplication between an input vector I^{V} and a sparse matrix C as shown in equation (1) where the non-zero elements of the sparse matrix C are the weights w of the filter W. The input vector I^{V} is the elements of the input tensor I unrolled from left to right and top to bottom (and front to back if 3D). Similarly the output vector O^{V} is the elements of the output tensor O unrolled.

$${O}^{V} = {I}^{V} {}^{★} C \qquad ( 1 A )$$

In contrast, a convolution transpose layer (which may also be referred to as a deconvolution layer, a transpose convolution layer, or a fractionally strided convolution layer) performs the reverse of a convolution operation. Specifically, in a convolution transpose layer the input tensor is processed by transposing the sparse matrix C for the corresponding direct convolution to generate a transposed sparse matrix C^{T} and performing a matrix multiplication between the input vector I^{V} and the transposed sparse matrix C^{T} as shown in equation (IB).

$${O}^{V} = {I}^{V} {}^{★} {C}^{T} \qquad ( 1 B )$$

Execution of convolutions and convolution transposes with small kernel heights and widths (typically 3×3 to 7×7) accounts for the majority of the computation in most convolutional neural networks. Thus, improvements to make convolution or convolution transpose operations efficient can increase the efficiency of various neural networks.

A neural network accelerator (NNA) is hardware that is designed to accelerate the processing of an NN. As is known to those of skill in the art, a hardware accelerator is hardware designed to perform a specific set of one or more functions more efficiently than a general processing unit, such as a central processing unit (CPU). Accordingly, in contrast to a general CPU which can be configured to perform any number of functions, an accelerator performs a relatively limited set of configurable application-specific functions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods of performing convolution efficiently adapting the Winograd algorithm are provided. Methods of convolving an input tensor with weights w use hardware comprising a plurality of linear operation engines as part of performing adaptations of a Winograd algorithm, the Winograd algorithm splitting each input channel i of a total of Cᵢₙ input channels into one or more tiles dᵢ and calculating a result A[Σᵢ₌₁^{Cin}(GwⱼᵢG^{T})∘(B^{T}dᵢB)]A^{T} for each output channel j, wherein G, B and A are constant matrices. The methods comprise determining a first filter F₁ from matrix B wherein the filter F₁ comprises n kernels, each kernel being an outer product of two columns of the matrix B; and using the linear operation engines to perform a convolution of the input tensor with the first filter F₁.

According to a first aspect, there is provided a method of convolving an input tensor with weights w using hardware comprising a plurality of linear operation engines, the method being an adaptation of a Winograd algorithm, the Winograd algorithm splitting each input channel i of a total of Cᵢₙ input channels into one or more tiles dᵢ and calculating a result A[Σᵢ₌₁^{Cin}(GwⱼᵢG^{T})∘(B^{T}dᵢB)]A^{T} for each output channel j, wherein G, B and A are constant matrices, the method comprising: determining a first filter F₁ from matrix B wherein the filter F₁ comprises n kernels, each kernel being an outer product of two columns of the matrix B; and using, the linear operation engines to perform a convolution of the input tensor with the first filter F₁. Optionally, the linear operation engines may be convolution engines. The input data may be any of text data, audio data, image data, volumetric data or multimodal data. The method may be part of a method of signal or image processing (including, for example, image classification, image segmentation, and optical character recognition), action recognition, semantic segmentation, or style transfer.

Optionally, the convolution of the input tensor with the first filter F₁ is performed for determining a tensor equivalent to B^{T}dᵢB, for all tiles of all input channels i.

The following features apply to a first subset of embodiments of the first aspect.

Optionally, the convolution of the input tensor with the first filter F₁ includes performing a first grouped convolution of each input channel i of the input tensor with the n kernels of the first filter F₁ to generate a first intermediate tensor having Cᵢₙ groups of n channels. The method may further comprise determining a tensor equivalent to Σᵢ₌₁^{Cin}(GwⱼᵢG^{T})∘(B^{T}dᵢB) by using the linear operation engines to perform a second grouped convolution with a weight tensor W′, the weight tensor W′ being composed of partial weight tensors W′ji, where each W′ji is determined from constant matrix G and is equivalent to GwⱼᵢG^{T}.

Optionally, Cin=1, and the second grouped convolution is a grouped convolution of the first intermediate tensor with the weight tensor W′. Alternatively optionally, Cᵢₙ≥2; and before performing the second grouped convolution, the method comprises permuting the channels of the first intermediate tensor to rearrange the Cᵢₙ groups of n channels into n groups of Cᵢₙ channels; and the second grouped convolution is a grouped convolution of the n groups of Cᵢₙ channels with the weight tensor W′.

Optionally, the second grouped convolution operation is performed by convolving each group of the first intermediate tensor with a corresponding part of the weight tensor W′ to generate a second intermediate tensor having n groups of Cₒᵤₜ channels. The method may further comprise determining a tensor equivalent to the result A[Σᵢ₌₁^{Cin}(GwⱼᵢG^{T})∘(B^{T}dᵢB)]A^{T} for each output channel j by using the linear operation engines to perform convolution transpose using a second filter F₂ to generate an output tensor having Cₒᵤₜ channels. Optionally, Cₒᵤₜ=1, and the convolution transpose is of the second intermediate tensor. Alternatively optionally, Cₒᵤₜ≥2; and before performing the convolution transpose, the method further comprises permuting the channels of the second intermediate tensor to rearrange the n groups of Cₒᵤₜ channels into Cₒᵤₜ groups of n channels; and the convolution transpose is of the Cₒᵤₜ groups of n channels.

Optionally, the second filter F₂ comprises a plurality of kernels, each kernel being an outer product of two columns of the matrix A.

Optionally, the first grouped convolution is a stride m convolution to generate an (h/m)×(b/m) first intermediate tensor, where m is equal to the output tile size of the Winograd algorithm being adapted.

Optionally, one or more of the first filter F₁, the second filter F₂, and the weight tensor W′ are precomputed and stored in a memory.

The following features apply to a second subset of embodiments of the first aspect.

Optionally, the convolution of the input tensor with the first filter F₁ includes performing n separate grouped convolutions of the Cᵢₙ input channels, each grouped convolution applying a corresponding kernel of the first filter F₁ to generate n separate first results, each having Cᵢₙ channels.

Optionally, the method further comprises, after performing the n separate grouped convolutions, concatenating the n first results to generate a first intermediate tensor having n groups of Cᵢₙ channels. Optionally, after performing the concatenation, the method further comprises: determining Σᵢ₌₁^{Cin}(GwⱼᵢG^{T})∘(BdᵢB^{T}) by using the linear operation engines, to perform a second grouped convolution (608) by convolving each group of the first intermediate tensor having Cᵢₙ channels with a corresponding part of the weight tensor W′ to generate a second intermediate tensor having n groups of Cₒᵤₜ channels, where W′ is determined from constant matrix G and is equivalent to the matrices GwⱼᵢG^{T} for all output channels j and input channels i; and permuting the channels of the second intermediate tensor having n groups of Cₒᵤₜ channels to generate Cₒᵤₜ groups of n channels; and determining the result A[Σ_{i=1,}^{Cin,}(GwⱼᵢG^{T})∘(BdᵢB^{T})]A^{T} by using the linear operation engines to perform convolution transpose of the second intermediate tensor using the second filter F₂ to generate an output tensor having Cₒᵤₜ channels.

Optionally, the method further comprises, after performing the n separate grouped convolutions to generate n separate first results, performing another n separate convolutions of each of the first results with a corresponding kernel of the weight tensor to generate n second results, each having Cₒᵤₜ channels. In one approach, after performing the another n separate convolutions, the method further comprises concatenating the n second results having Cₒᵤₜ channels to generate a second intermediate tensor having n groups of Cₒᵤₜ channels, and optionally, after performing concatenation, the method further comprises: permuting the channels of the second intermediate tensor having n groups of Cₒᵤₜ channels to generate Cₒᵤₜ groups of n channels; and determining the result A[Σ_{i=1,}^{Cin,}(Gwⱼᵢ G^{T})∘(BdᵢB^{T})]A^{T} by using the linear operation engines to perform convolution transpose of the second intermediate tensor using the second filter F₂ to generate an output tensor having Cₒᵤₜ channels. In another approach, after performing the another n separate grouped convolutions to generate n second results, the method further comprises interleaving the second results on a spatial axis to generate a third result, and optionally the method further comprises obtaining an output tensor having Cₒᵤₜ channels by performing a third grouped convolution followed by depth to space conversion.

According to a second aspect, there is provided a data processing system for implementing a neural network comprising a plurality of layers, wherein at least one of the layers is configured to perform an adaptation of a Winograd algorithm, the Winograd algorithm splitting each input channel i of a total of Cᵢₙ input channels into one or more tiles dᵢ and that calculates a result A[Σᵢ₌₁^{Cin}(Gwⱼᵢ G^{T})∘(B^{T}dᵢB)]A^{T} convolution of an input tensor with weights w as part of an adaptation of a Winograd algorithm, the Winograd algorithm splitting each input channel i of a total of Cᵢₙ input channels into one or more tiles dᵢ and calculating a result A[Σᵢ₌₁^{Cin}(Gwⱼᵢ G^{T})∘(B^{T}dᵢB)]A^{T} for each output channel j, wherein G, B and A are constant matrices, the data processing system comprising: a neural network accelerator comprising a plurality of linear operation engines implemented in a fixed-function hardware circuitry, wherein the data processing system is configured to: determine a first filter F₁ from matrix B wherein the filter F₁ comprises n kernels, each kernel being an outer product of two columns of the matrix B; and using the linear operation engines, perform a convolution of the input tensor with the first filter F₁. Optionally, the linear operation engines may be convolution engines.

Optionally, the data processing system further comprises a memory configured for storing a plurality of predetermined factors including the constant matrices G, B and A, a first filter based on matrix B, a second filter based on matrix A and a weight tensor W based on matrix G.

Optionally, the plurality of layers comprises a convolution layer and/or convolution transpose layer among other layers.

According to another aspect, there may be provided a data processing system for implementing a neural network configured to perform the methods according to any implementation of the first aspect.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1A is a block diagram of example data in a convolution operation;

FIG. 1B is a block diagram of an NNA hardware;

FIG. 2 is a flowchart illustrating the steps of a Winograd algorithm;

FIG. 3 illustrates a method of identifying filters for performing a Winograd based convolution operation;

FIG. 4A is a flowchart illustrating a method of performing convolution operations on an input tensor based on a Winograd algorithm;

FIG. 4B is a schematic diagram illustrating a convolution operation of an input tensor, implemented in hardware for an example NNA based on a Winograd algorithm;

FIG. 5 is a schematic diagram illustrating a convolution operation of an input tensor, having multiple input channels, implemented in hardware for an example NNA based on a Winograd algorithm;

FIG. 6 is a schematic diagram illustrating convolution operation of an input tensor, having multiple input and output channels, implemented in hardware for an example NNA based on a Winograd algorithm;

FIG. 7A illustrates a method for improving the efficiency of implementing a Winograd based convolution operation in hardware for an example NNA;

FIG. 7B illustrates another method of for improving the efficiency of implementing a Winograd based convolution operation in hardware for an example NNA;

FIG. 7C illustrates another method for improving the efficiency of implementing a Winograd based convolution operation in hardware for an example NNA;

FIG. 8 illustrates a computer system in which the Neural Network Accelerator described herein may be implemented; and

FIG. 9 shows an integrated circuit manufacturing system for generating an integrated circuit embodying a graphics processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

Many algorithms such as the Winograd family of algorithms have been proposed to increase the efficiency of performing convolutions operations. Winograd algorithms can reduce the number of calculations required for performing convolution compared to naïve implementations, and as such can be used to accelerate widely-used convolutions with small kernel sizes. The family of Winograd algorithms allow for a compute-efficient implementation of convolutions. Different kernel sizes require different versions of Winograd algorithm. In the paragraphs below, efficient implementations of the Winograd algorithm for the common case of 3×3 convolutions with stride 1×1 (i.e. convolution using 3×3 kernel size with stride of 1 in both spatial dimensions) on neural network accelerators are explained in detail. This version of the Winograd algorithm maps overlapping 4×4 input data tiles to non-overlapping 2×2 output data tiles, with stride 2×2 in both the input and the output. Mentions of “the Winograd algorithm” in the following description may refer to the specific example of Winograd for a 3×3 convolution with stride 1×1. However, it is understood that the same principles can be used to implement Winograd algorithms for other kernel sizes as well.

Although Winograd algorithms are computationally efficient compared to the standard convolution implementations, they pose challenges for implementation and execution on hardware such as neural network accelerators with dedicated, general convolution logic. This is because to implement the original Winograd algorithm in a naive fashion, millions of small matrix multiplications would need to be performed, which would be highly inefficient on this hardware.

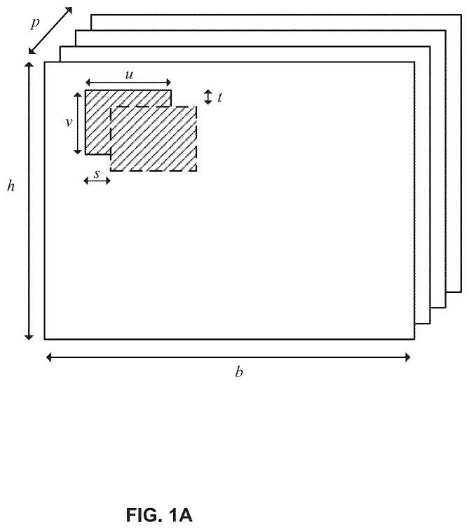

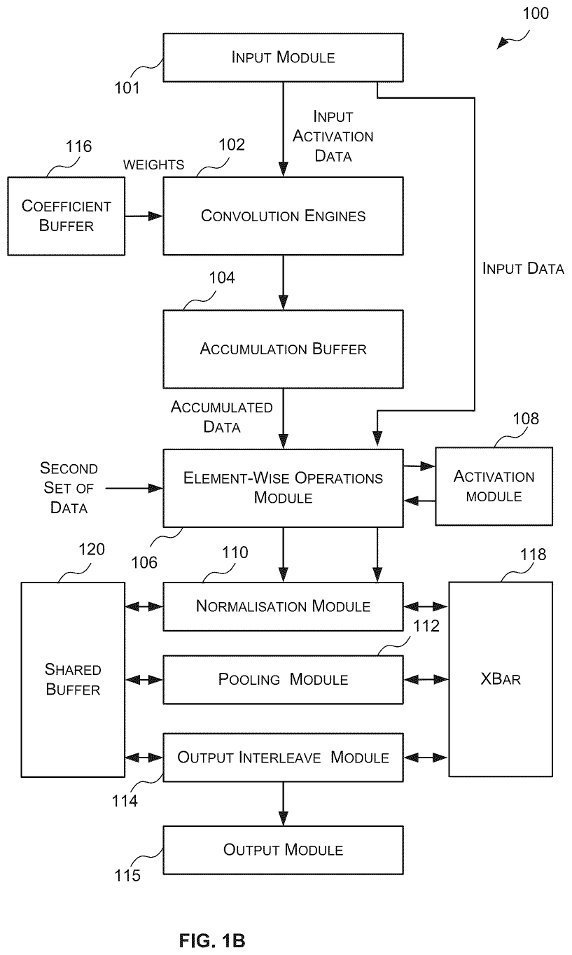

FIG. 1B, shows an exemplary neural network accelerator 100. NNAs generally have one or more hardware modules which are each designed to accelerate one or more neural network operations. Example neural network operations include, but are not limited to convolution operations, non-linear operations, pooling operations and normalisation operations.

The NNA 100 shown in FIG. 1B comprises an input module 101, convolution engines 102, an accumulation buffer 104, an element-wise operations module 106, an activation module 108, a normalisation module 110, a pooling module 112, an output interleave module 114 and an output module 115. Each module or engine implements or processes all or a portion of one or more types of layers. For example, together the convolution engines 102 and the accumulation buffer 104 implement or process a convolution layer or a fully connected layer. There are multiple convolution engines 102, which share weights and operate in parallel on adjacent windows of the input tensor. The element-wise operations module 106 is specialised at performing the same operation on every pair of respective elements of two tensors of corresponding shape and size. The activation module 108 processes or implements an activation layer (e.g. a ReLU or sigmoid activation). The normalisation module 110 processes or implements a normalisation layer. The pooling module 112 implements a pooling layer and the output interleave module 114 processes or implements an interleave layer.

The convolution engines 102 are configured to perform a convolution operation on the input data using the received weight data associated with a particular convolution layer. The input data may be any of the types already mentioned (e.g. text data, audio data, image data, volumetric data or multimodal data). The weights for each convolution layer may be stored in a coefficient buffer 116. The “XBar” 118 refers to a simple hardware module that contains configurable routing logic which connects multiple modules together in a dynamic fashion. For example, the XBar may dynamically connect the normalisation module 110, the pooling module 112 and/or the output interleave module 114 depending on which layers will be processed in the current hardware pass. The normalisation module 110, the pooling module 112, and the output interleave module 114 may each also have access to a shared buffer 120 which can be used by these modules 110, 112 and 114 to write and retrieve data. It will be evident to a person of skill in the art that this is just an example set of hardware modules that an NNA may have, and NNAs may have additional hardware modules, fewer hardware modules, a different combination of hardware modules, or different connections between hardware modules. It will also be evident that the convolution engines 102 are just an example of the type of hardware an NNA may employ which is optimised for efficiently performing large linear operations (e.g. matrix multiplications and convolutions on large tensors). As such, convolution engines 102 can be considered as an example of a more general group of linear operation engines, including other examples such as systolic arrays, that may be used in alternative architectures. Whilst the following discussion focuses on the disclosed architecture using convolution engines 102, the skilled person will understand that the various approaches described could be implemented on alternative hardware with alternative linear operation engines whilst still obtaining the described benefits.

The Winograd algorithm as usually presented maps overlapping tiles d of an input data tensor to non-overlapping tiles o of an output data tensor. In the general 2-dimensional case, the output tile o of the convolution between an input data tile d and weights w using the Winograd algorithm for a single input channel and single output channel can be expressed in matrix form as follows:

$$o = {A}^{T} [ ( ( G w {G}^{T} ) ∘ ( {B}^{T} dB ) ) ] A \qquad ( 2 )$$

where (for the aforementioned example of a stride-1 3×3 convolution) d is interpreted as a 4×4 matrix, w is interpreted as a 3×3 matrix, and A, B and G are constant matrices obtained by a known algorithm (such as the Cook-Toom algorithm, or other algorithms based on the Chinese remainder theorem). The original Winograd algorithm was for a single dimension, with the 2-dimensional extension of this algorithm (equation 2) being proposed later (Lavin and Gray (2015)). The input data d and the weights w are treated as matrices “sandwiched” between matrices B and its transpose, and G and its transpose, respectively, in a sequence of matrix multiplications as shown in the equation (2). For ease of explanation, operations of this form (e.g. B^{T} dB and GwG^{T}) are hereinafter referred to as “sandwich matrix multiplications” or “sandwich matrix products”. For example, “a sandwich matrix multiplication of d with B” means using B and its transpose to sandwich d in the sequence of matrix multiplications B^{T} dB. For the avoidance of doubt, the terms sandwich matrix multiplications/sandwich matrix product do not imply a specific order of the ‘sandwiching’ matrix and its respective transpose, but the order will be understood based on equation 2 for the given operation being considered. The operator ∘ represents Hadamard product, also referred to herein as element wise multiplication.

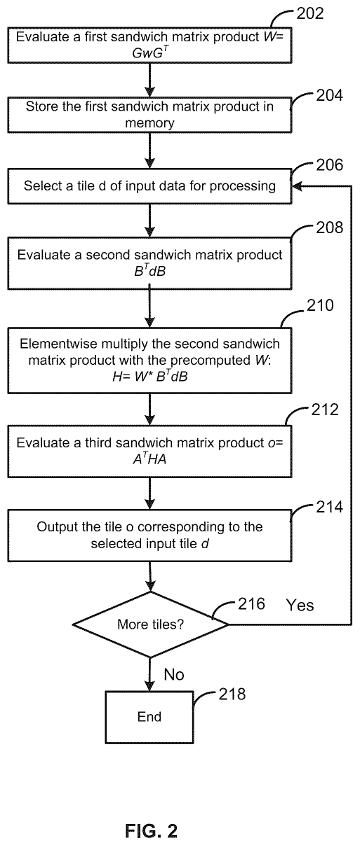

FIG. 2 is a flowchart illustrating the steps of the Winograd algorithm as described by equation (2). In step 202, the method comprises evaluating a first sandwich matrix product, i.e. a transformed weight matrix, W=GwG^{T} by a first sandwich matrix multiplication operation. The weights w may be provided from a memory to perform a first sandwich matrix multiplication operation as a first input. The constant matrix G (and the other matrices B and A) can be obtained as explained above based on known algorithms such as the Cook-Toom algorithm. These constant matrices can also be precomputed and stored in a memory. The matrix G is also provided to perform the first sandwich matrix multiplication operation as a second input. The result of the first sandwich matrix product (the transformed weight matrix) W can be also stored in the memory in step 204 and later the same transformed weight matrix W can be reused in the calculation of the Hadamard product across all the plurality of input tiles. It will be noted that steps 202 and 204 may be performed offline (that is, W may be precomputed) for use in steps 206-216 in the common case that constant weights are to be applied online to variable data.

An input tensor is received and is split into a plurality of tiles d. In step 206, a tile d of the input tensor is selected for processing as a first input to a second sandwich matrix multiplication operation. The constant matrix B is also provided to the second sandwich matrix multiplication operation as a second input. In step 208, the second sandwich matrix multiplication operation performs a sandwich matrix multiplication operation of the tile input data d with the constant matrix B to obtain a second sandwich matrix product B^{T}dB (i.e. transformed input data).

Once the transformed input data is obtained the next step, step 210, is to perform the elementwise multiplication or Hadamard product of the second sandwich matrix product (transformed input data) with the first sandwich matrix product W to obtain H. The first sandwich matrix product W may be provided as a first input and the second sandwich matrix product B^{T}dB may be provided as a second input for performing the elementwise multiplication.

Finally, in step 212, a third sandwich matrix multiplication operation of the output of Hadamard product H with the constant matrix A is performed to obtain an output tile o as a third sandwich matrix product A^{T}HA. The result of the element wise multiplication operation is provided as a first input and the constant matrix A is provided from memory as a second input to perform the third sandwich matrix multiplication operation. Further, in step 216, it is checked if there are any more tiles d of the input tensor to be processed. If so, the method proceeds to step 206, and steps 206 to 214 are performed. If not, then the method stops (step 218).

Consider an example of a 3×3 convolution. Let w be the 3×3 kernel and d be the 4×4 input tile with a single channel. The three constant matrices A, B and G would be predefined as A (dimensions 2×4), B (dimensions 4×4), G (dimensions 4×3). The output o which is the convolution of d with w would be calculated based on equation 2 following the steps described above, and will be a 2×2 tile.

In this example of 3×3 convolution, the Winograd algorithm allows the convolution of a 4×4 tile with a 3×3 filter to be calculated using only 16 multiplications instead of the 36 needed for the standard implementation. Thus, the Winograd algorithm is efficient in terms of the number of multiplications used with respect to the standard implementation of a convolution as a series of dot products, with the kernel sliding over the image as described above with reference to FIG. 1.

Further, for an input comprising Cᵢₙ input channels, but still a single output channel, only the sandwich matrix multiplications and the element-wise operation within the square brackets in equation (2) vary with the input channel. Therefore, the part inside the square brackets of equation (2) can be applied to each channel independently, for the corresponding kernel wᵢ, and then the results for each channel can be summed element-wise to obtain an output channel as shown in equation 3 below. Thus the equation (3) for multiple input channels would be represented as:

$$o = {\sum }_{i = 1}^{Cin} A ( G {w}_{i} {G}^{T} ) ∘ ( {Bd}_{i} {B}^{T} ) {A}^{T} = A [ {\sum }_{i = 1}^{Cin} ( G {w}_{i} {G}^{T} ) ∘ ( B {d}_{i} {B}^{T} ) ] {A}^{T} \qquad ( 3 )$$

where dᵢ represents the corresponding input tile data for each channel i and wᵢ are the corresponding kernels applied to input tile data for each channel. For multiple output channels, the process can be iterated for the different filters. This is more efficient than performing the multiplications involving A and A^{T} for each input channel and then calculating the sum at the end.

The implementation of the Winograd algorithm on hardware such as an NNA poses challenges because the naïve approach of splitting the input data into a plurality of tiles and performing matrix multiplication on each tile (as described above with reference to FIG. 2) is impractical to perform on such hardware. In other words, NNAs are not optimised for the combination of matrix multiplications and elementwise operations of the Winograd algorithm, but are more generally optimized for performing standard convolution operations. In particular, an NNA generally possesses dedicated hardware for processing convolution on data tensors by performing parallel operations using a plurality of convolution engines, and that convolution hardware will typically be optimised for large convolutions or matrix multiplications, which cannot be efficiently utilised on such small matrix multiplications. Splitting tensors into tiles and reconstituting the output tensor from the output tiles are also likely to be prohibitively expensive on such hardware.

However, the inventors have devised a method of efficiently implementing Winograd algorithms on hardware such as NNAs. In particular, the inventors have devised a method for mapping the steps of a Winograd algorithm into equivalent steps in terms of convolutions which can be efficiently implemented in hardware implementing standard convolution operations (that is, convolutions explicitly implemented as the windowed dot product described above with respect to FIG. 1). More specifically still, the inventors have devised an efficient method for converting the steps of Winograd algorithm, such as a sandwich matrix multiplications and element-wise multiplication operations, into equivalent standard convolution and convolution transpose operations, thus implementing the Winograd algorithm efficiently on hardware performing standard convolution operations. Systems and methods for efficient computation of the Winograd algorithm in terms of convolutions, for implementation on devices such as neural network accelerators without dedicated Winograd convolution support (e.g. in fixed-function hardware), are described below.

The inventors have recognised and exploited that the sandwich matrix multiplication of a matrix Y with two matrices X and its transpose X^{T}, is mathematically equivalent to performing convolution of Y with a certain filter constructed from matrix X. This filter can be determined based on matrix X where each kernel 302 is obtained as the outer product of two columns of matrix X.

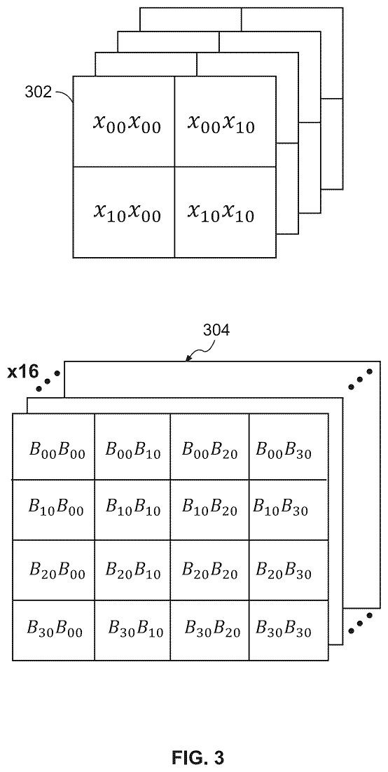

We now explain how a convolution kernel can be constructed to perform a sandwich matrix multiplication with respect to FIG. 3. Suppose X and Y are 2×2 matrices having 4 elements each as shown below:

$$X = [ \begin{matrix}{x}_{00} & {x}_{01} \\ {x}_{10} & {x}_{11}\end{matrix} ] Y = [ \begin{matrix}{y}_{00} & {y}_{01} \\ {y}_{10} & {y}_{11}\end{matrix} ]$$

The sandwich matrix multiplication X^{T}YX is mathematically equivalent to performing convolution of a tensor Y with a tensor in which each filter (hereinafter referred to as convolution kernel) is the outer product of two columns of the matrix X. Though X and Y are shown in this example as 2×2 matrices, the method can be extended easily to larger and non-square matrices.

By taking the outer product of different pairings of two columns of the matrix X (which is a 2×2 matrix), 4 kernels 302 are generated, each with 2×2 weights. The outer product of the first column with itself generates the first kernel having elements x₀₀x₀₀, x₀₀x₁₀, x₁₀x₀₀, x₁₀x₁₀ as shown. The outer product of the first column with the second column generates a second kernel having elements x₀₀x₀₁, x₁₀x₀₁, x₀₀x₁₁, x₁₀x₁₁. The outer product of the second column with the first column generates a third kernel having elements x₀₁x₀₀, x₁₁x₀₀, x₀₁x₁₀, x₁₁x₁₀. The outer product of the second column with itself generates a fourth kernel having elements x₀₁x₀₁, x₁₁x₀₁, x₀₁x₁₁, x₁₁x₁₁.

The convolution of the tensor Y with these kernels generates an output equivalent to the result obtained while performing the sandwich matrix multiplications operation X^{T}YX, since the sandwich matrix multiplications X^{T}YX can be expanded to give:

$${X}^{T} YX = [ \begin{matrix}{x}_{00} {x}_{00} {y}_{00} + {x}_{10} {x}_{00} {y}_{10} + {x}_{00} {x}_{10} {y}_{01} + {x}_{10} {x}_{10} {y}_{11} & {x}_{00} {x}_{01} {y}_{00} + {x}_{10} {x}_{01} {y}_{10} + {x}_{00} {x}_{11} {y}_{01} + {x}_{10} {x}_{11} {y}_{11} \\ {x}_{01} {x}_{00} {y}_{00} + {x}_{11} {x}_{00} {y}_{10} + {x}_{01} {x}_{10} {y}_{01} + {x}_{11} {x}_{10} {y}_{11} & {x}_{01} {x}_{01} {y}_{00} + {x}_{11} {x}_{01} {y}_{10} + {x}_{01} {x}_{11} {y}_{01} + {x}_{11} {x}_{11} {y}_{11}\end{matrix} ]$$

$${X}^{T} YX = [ \begin{matrix}{[ {x}_{00} {x}_{10} ]}^{T} [ {x}_{00} {x}_{10} ] * Y & {[ {x}_{00} {x}_{10} ]}^{T} [ {x}_{01} {x}_{11} ] * Y \\ {[ {x}_{01} {x}_{11} ]}^{T} [ {x}_{00} {x}_{10} ] * Y & {[ {x}_{01} {x}_{11} ]}^{T} [ {x}_{01} {x}_{11} ] * Y\end{matrix} ]$$

where * is the convolution operation.

In the case that the first matrix is not transposed and the second matrix is transposed, i.e. XYX^{T} rather than X^{T}YX, the kernels are instead produced as the outer products of the rows of X.

In FIG. 3, another filter 304 having 16 kernels, generated by taking the outer products of the rows of the constant matrix B for performing Winograd based convolution operations, is shown. Using the principle described above, this filter 304 can be further convolved with an input tile d to generate a 16-channel output with height and width of 1, which is equivalent to the 16 elements of the sandwich matrix product B^{T}dB in the present Winograd algorithm example.

Using the same method discussed above in relation to FIG. 3, filters can similarly be generated based on the constant matrices A and G for use in a Winograd algorithm implemented in terms of standard convolution operations. The following figures provide a detailed explanation of how each convolution operation performed on hardware (such as the example NNA) is equivalent to the steps of a Winograd algorithm.

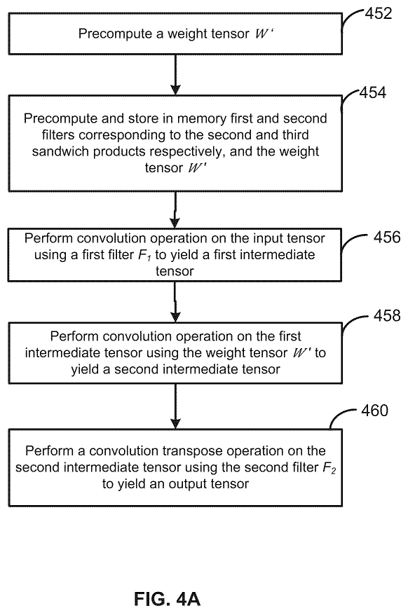

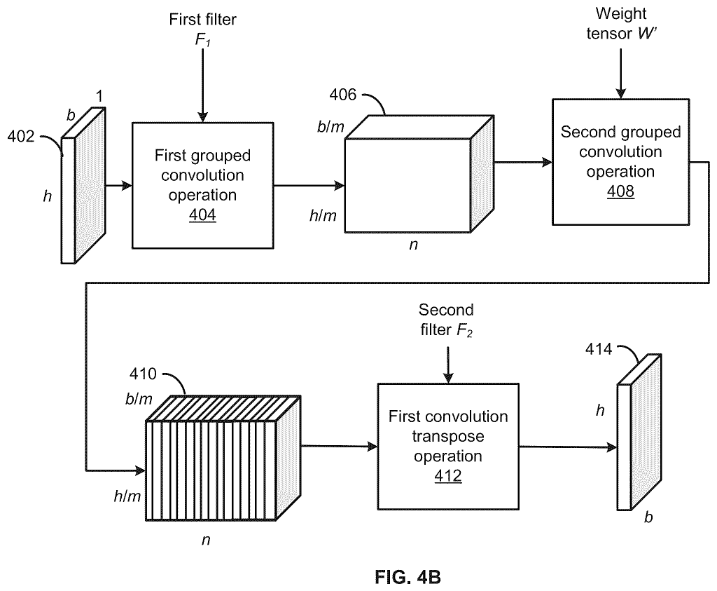

By generating filters based on the constant matrices A, B and G (used in Winograd algorithm) and performing convolution operation using these filters, a large number of small matrix multiplications on individual tiles can be converted into a small number of convolution operations on large tensors (e.g. FIG. 4) that run efficiently on hardware such as the example NNA. Doing such convolution operations on large tensors has many advantages and benefits compared to doing matrix multiplications as in the initial form of the Winograd algorithm described above with respect to equation 2. Performing convolution operations on large tensors is efficient on the example NNA hardware due to factors such as reuse of weights and data between applications of the convolution kernels to overlapping windows of input data, parallelism over multiple convolution engines etc. On the other hand, large numbers (up to millions) of very small matrix multiplications (as in the original Winograd algorithm) would be highly inefficient on the same hardware.

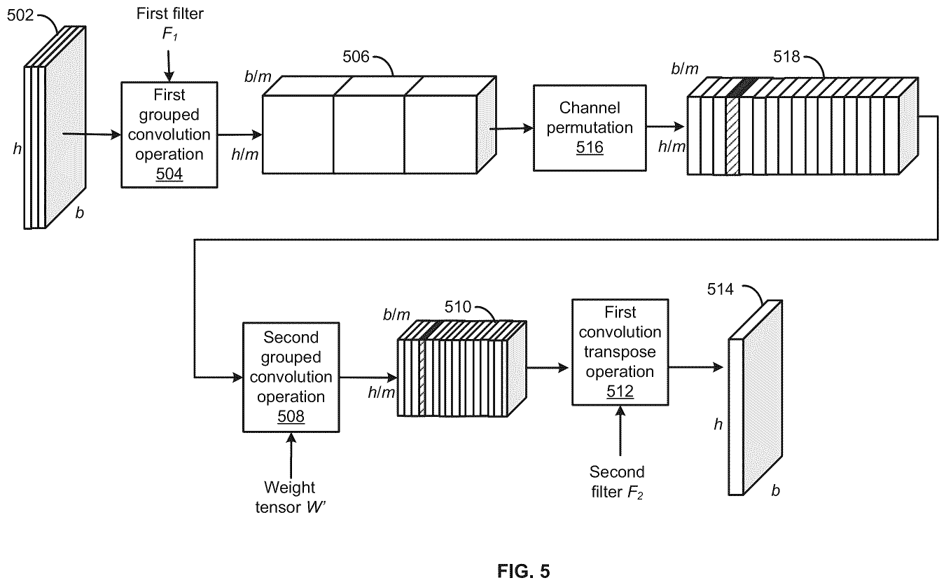

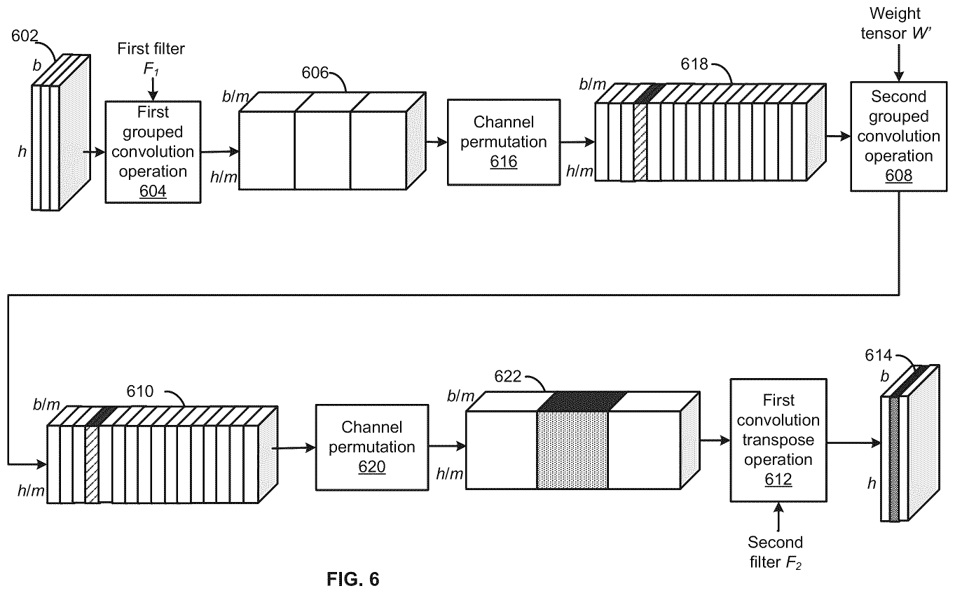

FIG. 4A is a flowchart illustrating convolution operations performed on an input tensor based on the Winograd algorithm. The convolution operations in FIG. 4A are explained in detail in conjunction with FIG. 4B, FIG. 5 and FIG. 6 below.

FIG. 4B illustrates a convolution operation of an input tensor with weights w, based on a Winograd algorithm, using a data processing system such as a neural network accelerator (NNA) comprising a plurality of convolution engines. The data processing system such as the NNA implements a neural network comprising a plurality of layers, where at least one of the layers is configured to perform operations based on a Winograd algorithm equivalent to convolution of an input tensor with weights w. FIG. 4B shows the simplest case of a generating a single-channel output from a single-channel input.

As explained above with reference to FIG. 2, the Winograd algorithm may be applied according to steps 202, 208, 210 and 212. FIG. 4A in conjunction with FIG. 4B, FIG. 5 and FIG. 6 explains how these steps can be implemented using much more efficient convolution operations on hardware such as the example NNA.

The convolution of the input tensor 402 with the original weights w is performed by the convolution engines of an NNA by performing convolution operations equivalent to the corresponding steps of the Winograd algorithm including sandwich matrix multiplications and Hadamard product (elementwise operation) as shown above.

In the first step 452 the method comprises precomputing a weight tensor W′. In the convolutional approach shown in FIG. 4B, the weight tensor W′ replaces the transformed weight matrix W (explained above as the result of calculating a first sandwich matrix product by performing a sandwich matrix multiplication operation GwG^{T}). The weight tensor W′ is of appropriate dimensions that can be applied to the result of the convolution operation equivalent to the sandwich product B^{T} dB. The weight tensor W′ is composed of elements determined from constant matrix G and the untransformed weights w. Since the transformed weight tensor is constant, it is preferably not calculated at runtime as a part of the convolution operation shown in FIG. 4B to save computation time, bandwidth, and energy. Instead, the transformed weight tensor may be precomputed and stored in memory (in step 454), for retrieval and use in executing the corresponding convolution operation in FIG. 4B. Since they are done “offline”, steps 452 and 454 may be performed on other, non-NNA hardware such as a microprocessor or a GPU.

The transformed weight matrix W (and by extension the weight tensor W) may be pre-calculated in one example by performing sandwich matrix multiplication of the G matrix with the weights w. In this case the transformed weight matrix W may be calculated by a unit in the system outside the convolution engines of the NNA, or by a unit outside of the system entirely (for example, a CPU in a desktop computer separate from the system containing the example NNA). For example, for a typical 3×3 convolution, w is a known 3×3 kernel and the 4×3 matrix G of the Winograd algorithm may be obtained by algorithms known in the art. Thus, performing sandwich matrix product of the G matrix with the weights w would generate a 4×4 transformed weight matrix having 16 coefficients. The elements of the weight matrix could then be arranged in a corresponding 4-dimensional weight tensor for use in the algorithm shown in FIG. 4B.

In another example the weight tensor W′ may be calculated by performing a convolution operation. To perform the convolution operation, a filter F_{w} is determined based on the matrix G. The filter F_{w} comprises convolution kernels determined as outer products of pairs of rows of the matrix G. The outer product is calculated as explained above with respect to FIG. 3.

Thus, starting from a p×q G matrix, we obtain p² kernels for filter F_{w}, each having q×q elements. In this particular example of 3×3 Winograd algorithm, starting from an 4×3 matrix, we obtain 16 kernels, each having shape 3×3. Once the kernels of the filter F_{w} are determined, the weight tensor W equivalent to the transformed weight matrix W is obtained by performing a convolution of the weights w with the kernels of the filter F_{w} to generate a weight tensor W′ having 16 elements. The order of the elements in the weight tensor is significant, since it must match the order of channels in the other operand of the Hadamard product. As mentioned above, the weight tensor may be precomputed separately before performing the Winograd algorithm.

The implementation of the Winograd algorithm illustrated in FIG. 4A and FIG. 4B is now explained. The method comprises receiving an input tensor 402 as an input. The input tensor 402 has a single input channel. However, in a general case the input tensor can have multiple input channels as described with respect to FIGS. 5 and 6 below. The input tensor 402 has a width (b) and height (h) and single input channel Cᵢₙ=1. Once the input tensor 402 is received, in step 456, a first grouped convolution operation 404 is performed on the input tensor 402 using a first filter F₁ to yield a first intermediate tensor 406. The first intermediate tensor 406 is equivalent to the result obtained by sandwich matrix multiplication B^{T} dB across all input tiles d in the input tensor. The first and second grouped convolution operations shown in FIG. 4B may be implemented at the convolution engines 102 of the NNA described above with reference to FIG. 1B.

Before performing the first grouped convolution operation 404, a first filter F₁ is determined based on the constant matrix B in equation 2 of the Winograd algorithm. The constant matrix B may be a square matrix of size p×p. For the present example of 3×3 stride-1 convolution, the constant matrix B is a 4×4 matrix. The matrix B is determined using known theorems as explained above based on e.g. the kernel size and stride of the convolution performed. The first filter F₁ is preferably precomputed and stored in the memory (step 454) to be used in the first grouped convolution operation 404 by the convolution engines. The first filter F₁ comprises convolution kernels which are determined as outer products of pairs of columns of the matrix B. Again, the outer product is calculated in the way explained above with respect to FIG. 3.

Thus, starting from a p×p B matrix, we obtain n=p² kernels for the first filter F₁, each being of shape p×p. In this particular example of 3×3 Winograd algorithm, starting from an 4×4 matrix B, we obtain 16 kernels, each having shape 4×4. Thus, F₁ may for example be a tensor of shape [4, 4, 1, 16], where the dimensions represent the kernel height, kernel width and number of input and output channels respectively. When convolved with the input data, this generates 16 output channels, corresponding to the elements of the sandwich matrix product (i.e., transformed data matrix) B^{T} dB. Care is taken to match the order of kernels in F₁ (i.e. the order of output channels) to the order of elements in the transformed weight tensor W′. The convolution kernels of the filter determined based on matrix B are shown as 304 in FIG. 3.

While performing the first grouped convolution operation 404 according to step 456, the input tensor 402 is not split into overlapping tiles. Instead of splitting the input tensor into overlapping tiles, the convolution operation is applied as a stride-m convolution on the entire input tensor to obtain the desired overlap. The stride of this convolution matches the stride of the overall Winograd algorithm being implemented. For the current example, the Winograd algorithm has a stride of 2 (inherited from the output tile size which is 2×2 in this case), so the output of the first grouped convolution operation 404 would have half the height (h) and width (b) of the input tensor. Thus, the first intermediate output 406 would have a tensor height (h/2) and tensor width (b/2).

Applying the first grouped convolution operation 404 of the input tensor with the first filter F₁ includes performing a first grouped convolution of each input channel of the input tensor with the first filter F₁ to generate a first intermediate tensor 406. In the example case shown in FIG. 4B, the input tensor 402 comprises only a single channel and hence the convolution involves convolution of the single input channel of the input tensor with the n kernels of the first filter F₁ to generate a first intermediate tensor (that is, in this special case of a single input channel, since the number of groups is one, the implementation does not need to take groups into account). Thus, in the above example, the first intermediate tensor would have 16 channels, as the single channel of the input tensor is convolved with 16 kernels. These 16 channels of the first intermediate tensor 406 are equivalent to the transformed input data B^{T} dB for each corresponding input tile d.

Once the first intermediate tensor 406 is determined, in step 458 a second grouped convolution operation 408 is performed on the first intermediate tensor 406 using the weight tensor W′ to yield a second intermediate tensor 410. The second intermediate tensor 410 is equivalent to the Hadamard product H=W∘B^{T}dB across all input tiles d. The weight tensor W′ contains the 16 elements equivalent to the 16 elements of the 4×4 transformed weight matrix W, arranged such that they are applied to the corresponding elements of the first intermediate tensor 406 (i.e. the transformed input data) to generate n groups of a number of output channels (in the example shown in FIG. 4B, this is 16 groups of 1 output channel each). Various methods of determining the weight matrix are discussed in detail above.

In other words, the second grouped convolution operation 408 of the first intermediate tensor 406 with the weight tensor applies the n elements of the weight tensor W′ on the first intermediate tensor 406 in a 1×1×1×1 (x n) convolution, where n is the number of groups. In FIG. 4B, in the present example of 3×3 convolution, the weight tensor W′ comprises 16 kernels which are 1×1 elements applied on 16 corresponding channels of the first intermediate tensor. Thus, the second grouped convolution comprises 16, 1×1×1×1 convolutions. The second grouped convolution is applied with a stride of 1. A stride 1 convolution keeps the spatial resolution of the second intermediate tensor 410 the same as the first intermediate tensor 406. Thus, the second intermediate tensor 410 has a tensor height (h/2) and tensor width (b/2).

Once the second intermediate tensor 410 is determined, then in step 460, a first convolution transpose operation 412 (also known as a “deconvolution” operation) is performed on the second intermediate tensor 410 using the second filter to yield an output tensor 414. The output tensor 414 obtained is equivalent to the sandwich matrix product A^{T}HA, and is the output of the Winograd algorithm being implemented. To perform the first convolution transpose operation 412, the second filter F₂ is determined based on the matrix A precomputed based on the known theorems as explained above. The second filter F₂ is preferably precomputed and stored in the memory (in step 454) to be used in the convolution transpose operation 412 by the convolution engines. The second filter F₂ comprises convolution kernels which are determined as outer products of two columns of the matrix A. Again, the outer product is calculated in the way explained above with respect to FIG. 3.

Starting from a p×r matrix, we obtain r² kernels, each being a p×p matrix. In this particular example of 3×3 Winograd algorithm, starting from an 4×2 matrix A, we obtain 4 kernels, each having shape 4×4. The convolution transpose operation 412 equivalent to the sandwich matrix multiplication A^{T} HA involves performing a convolution transpose operation of the second intermediate tensor 410 with the second filter F₂ having kernels generated based on matrix A. Each kernel of F₂ contains the 16 elements of the corresponding 4×4 transformed kernel obtained from A as described above, arranged such that they are applied to the corresponding elements of the first intermediate tensor. The kernels themselves are arranged so that they give 4 distinct spatial outputs, i.e. the shape of F₂ may be given as [2, 2, 16, 1] (in which the dimensions are kernel height, kernel width, input channels and output channels respectively). A convolution transpose operation is used instead of a standard 1×1 convolution operation in order to arrange the results spatially in 2×2 output tiles in tensor 414, rather than as channels in an intermediate tensor, as was the case before with the first grouped convolution operation 404. The convolution transpose operation may be executed on the convolution engines of the example NNA.

In the example case shown in FIG. 4A and FIG. 4B, instead of performing a 1×1 convolution to obtain 4 output channels, a deconvolution or convolution transpose operation is performed to obtain a single channel output with the outputs arranged spatially in non-overlapping 2×2 blocks. By striding this convolution transpose operation by 2, all required non-overlapping 2×2 output tiles are yielded by this operation, and correct output resolution (h, b) is achieved. In the second filter, the 16 elements from each output spatial location's corresponding 4×4 matrix are arranged on the input channel axis to convolve with the second intermediate tensor.

Matching the convolution transpose kernel size to the output stride means that there is no overlap between output tiles, which is important for correct implementation of the Winograd algorithm, since each spatial location in tensor 410 contributes to exactly one corresponding output tile of dimensions m×m, where m is the kernel size of the convolution transpose, the stride of the convolution transpose, the size of the output tiles, and the stride of the first grouped convolution operation 404. In general, while performing the convolution transpose operation, an output stride m is used to obtain an output of desired size. In the current example, m=2. For example, a stride 2 convolution transpose operation brings the size of the output tensor back to that of the input tensor. When a stride 2 convolution transpose operation is applied, the spatial resolution is doubled from that of the second intermediate tensor, so that a resolution of (h/2, b/2) becomes (h, b). These output tiles correspond exactly to the output tiles in the original matrix formulation of the 2D Winograd convolution algorithm.

FIG. 5 illustrates a convolution operation (described with respect to FIG. 4A) of an input tensor having multiple input channels with weights w based on a Winograd algorithm, for efficient implementation using a neural network accelerator comprising a plurality of convolution engines. FIG. 5 shows a use case in which an output with a single channel is generated from an input having Cᵢₙ multiple channels. For multiple input channels, we need to introduce a summation over all input channels into the implementation of the Winograd algorithm. The Winograd algorithm for multiple input channels may be represented using equation (3) provided above.

As explained above, the convolution of the input tensor 502 with the weights w is performed, by the convolution engines, by performing equivalent standard convolution operations replacing the corresponding steps of the sandwich matrix multiplications and Hadamard product (elementwise operation) in the above equation (3).

The method includes, at step 452, precomputing a weight tensor W′. In this case, a partial weight tensor Wᵢ′, replaces a weight matrix Wᵢ (calculable by a first sandwich matrix product GwᵢG^{T}) for each input channel i. Each partial weight tensor Wᵢ′ is formed by arranging the corresponding transformed weight matrix Wᵢ in a particular order to form a tensor. The weight tensor W′ is composed of the partial weight tensors Wᵢ′ corresponding to each input channel, each partial weight tensor being composed of sets of elements determined based on the constant matrix G such that Wᵢ′ is equivalent to GwᵢG^{T}. The weight tensor is preferably precomputed before performing the first grouped convolution operation 504, and stored in a memory (in step 454). The various methods of calculating the weight tensor are explained with respect to FIG. 4B above. The elements of the weight tensor are arranged such that the weight tensor can be used to compute a group of 16 1×1×Cᵢₙ×1 convolutions using a grouped convolution operation (the size of the group, in this case 16, will depend on the exact Winograd algorithm being implemented), where Cᵢₙ is the number of input channels. This may, for example, be achieved by constructing the partial weight tensors to have shape [16, 1, 1, 1, 1], and concatenating on the 4th axis to obtain a tensor with shape [16, 1, 1, Cᵢₙ, 1], where the first axis is understood to denote the group, and the following 4 axes are understood to denote the dimensions of the filter for each group, namely kernel height, kernel width, number of input channels, and number of output channels respectively.

The first grouped convolution operation 504 of an input tensor 502 with weights wᵢ for all input channels i, based on a Winograd algorithm is depicted in FIG. 5. The method comprises receiving an input tensor 502. The input tensor 502 in FIG. 5 has a width (b), a height (h), and a number of input channels Cᵢₙ. In FIG. 5, the number of input channels is considered as three, i.e. Cᵢₙ=3. Once the input tensor 502 is received, in step 456, the method involves performing a first grouped convolution operation 504 on the input tensor 502 using a first filter to yield a first intermediate tensor 506. The first intermediate tensor 506 determined is equivalent to the sandwich matrix product B^{T}dᵢ B across all input tiles d and channels i.

To perform the first grouped convolution operation, a first filter F₁ is determined based on the matrix B. The first filter F₁ is preferably precomputed and stored in the memory (in step 454) to be used in the grouped convolution operation by the convolution engines. The first filter F₁ is obtained in a similar manner, replicated across the multiple input channels, to that described above in the context of FIG. 4B and comprises convolution kernels which are determined as outer products of pairs of columns of the matrix B as explained with respect to FIG. 4B. Thus, starting from a p×p matrix B, we obtain n=p² kernels, each being a p×p matrix. In this particular example of 3×3 Winograd algorithm, starting from a 4×4 matrix B, we obtain 16 kernels, each having 16 elements (i.e. a shape 4×4). To perform the grouped convolution operation on Cᵢₙ input channels, 4 copies of the first filter F₁ are arranged and provided as an input from the memory (the precomputed first filter F₁ having been stored in the memory in step 454). Thus F₁, for example, may be a tensor of shape [Cᵢₙ, 4, 4, 1, 16], where the first axis is understood to denote the group, and the following 4 axes are understood to denote the filter for each group respectively.

Thus, the first grouped convolution operation 504 involves convolving each input channel of the input tensor 502 with the corresponding n kernels of the first filter F₁ for each of the Cᵢₙ groups, to generate a first intermediate tensor 506 having Cᵢₙ groups of n channels. In the example case shown in FIG. 5, the input tensor 502 comprises three input channels. Hence the first grouped convolution involves convolution of each input channel of the three input channels of input tensor 502 with the 16 kernels of the first filter F₁ to generate a first intermediate tensor 506. The first grouped convolution operation in the example of FIG. 5 is a [3, 4, 4, 1, 16] convolution. Thus, the first intermediate tensor would have three groups of 16 channels. These three groups of 16 channels of the first intermediate tensor 506 are thus equivalent to the transformed input data B^{T}dᵢB over all input tiles d.

While performing the grouped convolution operation, the input tensor 502 is not split into overlapping tiles. Instead of splitting the input tensor into overlapping tiles, a stride m convolution operation is performed to obtain an output of desired size of output patch per tile. For example, a stride 2 convolution operation is performed. As discussed above, the stride of this convolution matches the stride of the overall Winograd algorithm being implemented. For the current example, where m=2, the output of the grouped convolution operation (i.e. the first convolution operation 504) would have half the resolution of tensor height (h) and tensor width (b) of the input tensor. Thus, the first intermediate output 506 would have a tensor height (h/2) and tensor width (b/2).

Once the first intermediate tensor 506 is determined, in step 458, a second grouped convolution operation 508 is performed on the first intermediate tensor 506 using the weight tensor W′ to yield a second intermediate tensor 510. The second intermediate tensor 510 is equivalent to the Hadamard product with cross-channel sum, H=[Σᵢ₌₁^{Cin}(Gwᵢ G^{T})∘(BdᵢB^{T})], across all input tiles d and all channels i. This Hadamard product could be implemented in multiple ways with differing suitability for the example NNA hardware.

One way to achieve the result of the Hadamard product would be to perform a convolution directly on the Cᵢₙ×16 channels with an ungrouped convolution operation (not shown in FIG. 5). In other words, a method noted by the inventors to be suboptimal and inefficient would be to use a single, ungrouped convolution to perform the Hadamard product. This convolution would have a kernel of shape [1, 1, 16 Cᵢₙ, 16]. Collapsing the first two dimensions and representing as a matrix, this kernel would have the form:

$$[ \begin{matrix}{W}_{0}^{0} & 0 & … & 0 & {W}_{1}^{0} & 0 & … & 0 & {W}_{2}^{0} & 0 & … & 0 \\ 0 & {W}_{0}^{1} & … & 0 & 0 & {W}_{1}^{1} & … & 0 & 0 & {W}_{2}^{1} & … & 0 \\ ⋮ & ⋮ & ⋱ & ⋮ & ⋮ & ⋮ & ⋱ & ⋮ & ⋮ & ⋮ & ⋱ & ⋮ \\ 0 & 0 & … & {W}_{0}^{15} & 0 & 0 & … & {W}_{0}^{15} & 0 & 0 & … & {W}_{2}^{15}\end{matrix} ]$$

This method performs both the Hadamard product and the cross-channel sum, as required. However, the fact that 15 out of every 16 elements in this kernel is zero means that this will not make efficient use of NNAs implementing standard convolutions. Instead, a corresponding method using dense kernels is preferable. The inventors have devised that, provided the channels can be rearranged into block diagonal form as shown in the matrix below, a grouped convolution operation with a dense [16, 1, 1, 1, Cᵢₙ] filter can be used, which would be considerably more efficient:

$$[ \begin{matrix}{W}_{0}^{0} & {W}_{1}^{0} & {W}_{2}^{0} & 0 & 0 & 0 & … & 0 & 0 & 0 \\ 0 & 0 & 0 & {W}_{0}^{1} & {W}_{1}^{1} & {W}_{2}^{1} & … & ⋮ & ⋮ & ⋮ \\ ⋮ & ⋮ & ⋮ & ⋮ & ⋮ & ⋮ & ⋱ & 0 & 0 & 0 \\ 0 & 0 & … & 0 & 0 & 0 & … & {W}_{2}^{15} & {W}_{2}^{15} & {W}_{2}^{15}\end{matrix} ]$$

This effectively skips all the zero weights entirely and leaves us with dense operations. The grouped kernels correspond to the blocks on the diagonal of this matrix, and are as given below:

$$[ {W}_{0}^{0} {W}_{1}^{0} {W}_{2}^{0} ] , [ {W}_{0}^{1} {W}_{1}^{1} {W}_{2}^{1} ] , … [ {W}_{0}^{15} {W}_{1}^{15} {W}_{2}^{15} ]$$

Thus in order to perform the step of element wise operation or Hadamard product with cross-channel sum efficiently using a dense kernel, a channel permutation 516 on the Cᵢₙ groups of 16 channels can first be performed. The channel permutation 516 rearranges the elements of the first intermediate tensor 506 such that further convolution can be performed efficiently. For Cᵢₙ≥2, permuting the channels of the first intermediate output tensor 506 includes rearranging the Cᵢₙ groups of n channels into n groups of Cᵢₙ channels. In other words, the channel permutation 516 groups elements with the same position within each group of Cin channels together, for processing together. Hence the result obtained after the channel permutation is the first intermediate tensor with its elements rearranged.

The weight tensor may be constructed by first precomputing the transformed weight matrices for each kernel, forming Cᵢₙ matrices of shape 4×4 in the present example. In order to apply these efficiently as a grouped convolution (i.e. second grouped convolution operation 508), these can be represented as a weight tensor of dimensions [16, 1, 1, Cᵢₙ, 1], where the 4×4 matrices are arranged along the first (group) dimension. When applied as a second grouped convolution, this processes each group of Cᵢₙ channels independently, as required. Also, the grouped convolution is performed as a stride 1 convolution. Stride 1 convolution would keep the spatial resolution of the second intermediate tensor 510 the same as the permuted first intermediate tensor 518. Thus, the second intermediate tensor would have a height of (h/2) and width of (b/2). Hence the second intermediate tensor 510 equivalent to the result of element wise operation H=W∘B^{T}dB=[Σᵢ₌₁^{Cin}(Gwᵢ G^{T})∘(BdᵢB^{T})] is obtained. The second intermediate tensor 510 comprises 16 groups of Cₒᵤₜ channels (where Cₒᵤₜ is 1 in the present example). The summation over all input channels across all input tiles while determining the Hadamard product is thus efficiently handled by permuting (i.e. grouping together) Cᵢₙ channels and then applying the weights on all Cᵢₙ channels in each group in the following grouped convolution (second grouped convolution).

Once the second intermediate tensor 510 is determined, then in step 460, a first convolution transpose operation 512 is performed on the second intermediate tensor 510 using the second filter to obtain an output tensor 514 equivalent to the sandwich matrix product A^{T}HA. The convolution transpose operation 512 is performed in the same manner as the first convolution transpose operation 412 in obtaining the output tensor 410 as explained above in conjunction with FIG. 4B

FIG. 6 illustrates a convolution operation (explained with respect to FIG. 4A) of an input tensor, having multiple input channels, with weights w, based on a Winograd algorithm, using a neural network accelerator comprising a plurality of convolution engines. FIG. 6 shows a use case in which an output having Cₒᵤₜ channels is generated from an input having Cᵢₙ channels.

The Winograd algorithm for multiple input channels and multiple output channels can be represented using equation 4 as:

$$\begin{matrix}{o}_{j} = {\sum }_{i = 1}^{Cin} A ( G {w}_{ji} {G}^{T} ) ∘ ( B {d}_{i} {B}^{T} ) {A}^{T} \\ = A [ {\sum }_{i = 1}^{Cin} ( G {w}_{j i} {G}^{T} ) ∘ ( B {d}_{i} {B}^{T} ) ] {A}^{T}\end{matrix} \qquad ( 4 )$$

where dᵢ is the corresponding input tile data for each channel i, wⱼᵢ are the kernels applied to each output channel j and input channel i, and oⱼ is the content of the j^{th} channel of the output tensor.

As explained above, the convolution of the input tensor 602 with the weights w is performed by the convolution engines by performing steps of equivalent convolution operations replacing the corresponding steps of the sandwich matrix multiplications and Hadamard product (elementwise multiplication) in the above equation.

The method includes in step 452, precomputing a weight tensor W′. In this case, a partial weight tensor W′ⱼᵢ replaces a weight matrix Wⱼᵢ (calculable by a first sandwich matrix product GwⱼᵢG^{T}) for each input channel i and output channel j. The weight tensor W′ is composed of partial weight tensors W′ⱼᵢ corresponding to each input and output channel, being composed of sets of elements determined from constant matrix G, such that W′ⱼᵢ is equivalent to GwⱼᵢG^{T}. The weight tensor is preferably precomputed before performing convolution operation shown in FIG. 6, and stored in a memory. The various method of calculating the weight matrices is same as that explained with respect to FIG. 4B above. In the present example of 3×3 convolution, wⱼᵢ can be considered as a 3×3 matrix, and Wⱼᵢ=GwⱼᵢG^{T} as a 4×4 matrix.

The implementation of a convolution operation of an input tensor 602 with weights wⱼᵢ, based on a Winograd algorithm depicted in FIG. 6 is explained in detail here. The method comprises receiving an input tensor 602. The input tensor 602 in FIG. 6 has a width (b) and height (h) and number of input channels Cᵢₙ. In FIG. 6, the number of input channels is provided as three, i.e. Cᵢₙ=3. Once the input tensor 602 is received, in step 456, the first grouped convolution operation 604 is performed on the input tensor 602 using the first filter to the input tensor to yield a first intermediate tensor 606. The first intermediate tensor 606 is equivalent to the sandwich matrix product B^{T}dᵢB across all input tiles d and channels i, the output of which is hereinafter referred to as a first intermediate tensor 606. The input tensor 602 and the first intermediate tensor 606 in the example shown in FIG. 6 is same as the input tensor 502 and the first intermediate tensor 506 in the example shown in FIG. 5. Thus, the steps of the convolution operation to determine the first intermediate tensor 606 are the same as those explained above with respect to FIG. 5 in determining the first intermediate tensor 506.

Once the first intermediate tensor 606 is determined, in step 458 a second convolution operation 608 is performed on the first intermediate tensor 606 using the weight tensor W′ to yield a second intermediate tensor 610. The second intermediate tensor 610 is equivalent to the Hadamard product with cross-channel sum, Hⱼ=[Σᵢ₌₁^{Cin}(GwⱼᵢG^{T})∘(BdᵢB^{T})], across all input tiles d and all input channels i. The weight tensor is now retrieved from the memory to perform the convolution equivalent to Hⱼ.

Now Hadamard operation can be achieved in many ways as explained above with reference to FIG. 5. In order to perform the step of element wise operation or Hadamard product efficiently, a channel permutation 616 on the Cᵢₙ groups of n channels can be performed in the same manner as the channel permutation 516, as explained with respect to FIG. 5.

Thus, once the channel permutation 616 is performed, we would get the permuted first intermediate tensor 618 having n groups each with a depth of Cᵢₙ (that is, each group having Cᵢₙ channels). The second grouped convolution operation 608, equivalent to the Hadamard product with cross-channel sum, is now performed. The second grouped convolution operation 608 convolves the permuted first intermediate tensor 618 with the precomputed weight tensor W′ⱼᵢ. The weight tensor W′ⱼᵢ may be considered as having shape (16, 1, 1, Cᵢₙ, Cₒᵤₜ), with the axes indicating group, kernel height, kernel width, input channels and output channels respectively. The weight tensor may be constructed by first precomputing, for a given output channel, the transformed weight matrices for each kernel, forming Cᵢₙ matrices of shape 4×4 in the present example. This may be repeated for each output channel, resulting in Cₒᵤₜ kernels of shape [16, 1, 1, Cᵢₙ, 1], which may be concatenated on the last axis to produce a tensor of shape [16, 1, 1, Cᵢₙ, Cₒᵤₜ] for efficient application as a grouped convolution (i.e. second convolution operation 608), in which the 4×4 matrices are arranged along the first (group) dimension. When applied as a second grouped convolution, this processes each group of Cᵢₙ channels independently, as required, to produce n groups of Cₒᵤₜ output channels. The second grouped convolution is therefore, in effect, performing a separate standard (dense) convolution with Cᵢₙ input channels and Cₒᵤₜ output channels on each of the 16 groups.

Once the second intermediate tensor 610 is determined, the output tensor 614 needs to be determined. To obtain the output tensor, an ungrouped convolution transpose could in principle be performed directly on the 16×Cₒᵤₜ channels of the second intermediate tensor 610, which the inventors note would be less efficient due to sparsity in the filter F₂, as explained above with respect to calculating Hadamard product with cross-channel sum directly on the first intermediate tensor 506 in FIG. 5. In order to perform the step of convolution transpose efficiently, another channel permutation to group Cₒᵤₜ groups of n channels can be performed (which in this example, would result in 3 groups of 16 channels). Thus, in order to perform the convolution transpose operation 612 efficiently, a channel permutation 620 on the n groups of Cₒᵤₜ channels in tensor 610 can first be performed. The channel permutation 620 rearranges the elements of the second intermediate tensor 610 such that further convolution can be performed efficiently. For Cₒᵤₜ≥2, permuting the channels of the second intermediate output tensor 610 involves rearranging the n groups of Cₒᵤₜ channels into Cₒᵤₜ groups of n channels. In other words, the channel permutation 620 groups elements with the same position within each group of Cₒᵤₜ channels together, for processing together. Hence the result obtained after the channel permutation 620 is the second intermediate tensor 610 with its elements rearranged to obtain the permuted second intermediate tensor 622.

Once the permuted second intermediate tensor 622 has been obtained, then in step 460, a convolution transpose operation 612 equivalent to the sandwich matrix product A^{T}HⱼA is performed to obtain an output tensor 614. To perform the convolution transpose operation 612, a second filter F₂ is determined based on the matrix A precomputed based on the known theorems as explained earlier. The second filter F₂ is preferably precomputed and stored in the memory (step 454) to be used in the convolution transpose operation 612 by the convolution engines. The second filter F₂ comprises convolution kernels which are determined as outer products of two columns of the matrix A as explained earlier with respect to FIG. 4B. Each kernel of F₂ contains the 16 elements of the corresponding 4×4 transformed kernel obtained from matrix A as described above, arranged such that they are applied to the corresponding elements of the second intermediate tensor. The kernels themselves are arranged so that they give 4 distinct spatial outputs, i.e. the shape of F₂ may be given as Cₒᵤₜ copies of the same values in our filter, which is of shape [Cₒᵤₜ, m, m, n, 1] i.e. in the present example [3, 2, 2, 16, 1]. The convolution transpose operation is executed on the convolution engines of the example NNA.

The convolution transpose operation 612 is performed on the permuted second intermediate tensor 622 with the second filter F₂, by performing a convolution transpose on each of the Cₒᵤₜ groups of n channels of the permuted second intermediate tensor 622, with each group of the second filter F₂, to generate the output tensor 614. In the example case a deconvolution or convolution transpose is performed on each group of 16 channels of the permuted second intermediate tensor 622 with each kernel of the second filter F₂ to obtain the output tensor 614 having three output channels. Thus, the convolution transpose is performed by performing a grouped convolution of shape (3, 2, 2, 16, 1) (in which the dimensions are, as before, group, kernel height, kernel width, input channels and output channels respectively) to yield the output tensor with Cₒᵤₜ channels. In the second filter, the 16 elements from each 4×4 matrix are arranged on the input channel axis.

In general, while performing the convolution transpose operation, a stride of m is used to obtain an output of desired size. For example, a stride-2 convolution transpose operation is performed to bring back the width and size of the input same as the input tensor. When a stride-2 convolution transpose operation is applied, the spatial resolution of the second intermediate tensor is doubled. In other words, the output would have double the resolution of tensor height (h/2) and tensor width (b/2) of the second intermediate tensor. Thus, the output would have a tensor height (h) and tensor width (b), as we apply stride 2.

The inventors further investigated methods to make the implementation of Winograd algorithm more efficient still on hardware for performing convolution operations such as the example NNA. The inventors found that NNAs may not be optimised for performing channel permutations, often being more optimised for performing convolutions. That is, even if a permutation notionally makes it possible to perform the next steps more efficiently, if the permutation itself cannot be performed efficiently then there may be no overall gain in efficiency. Hence the inventors devised methods of implementing the Winograd algorithm that eliminate channel permutations, thus achieving greater overall efficiency.

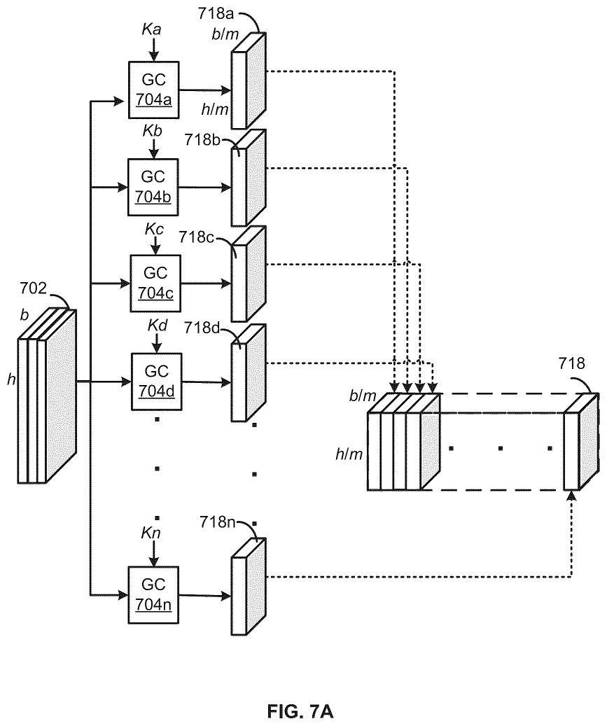

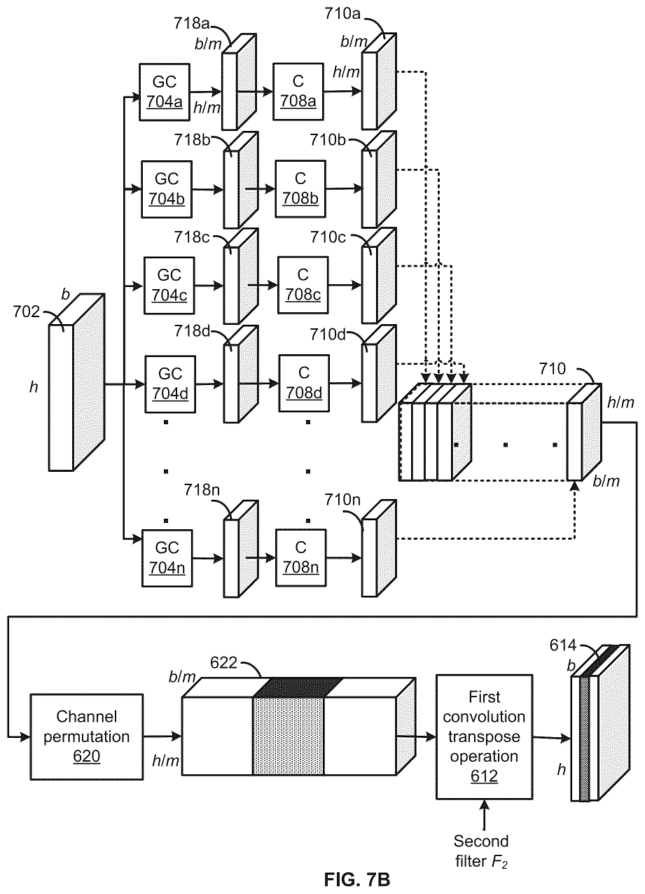

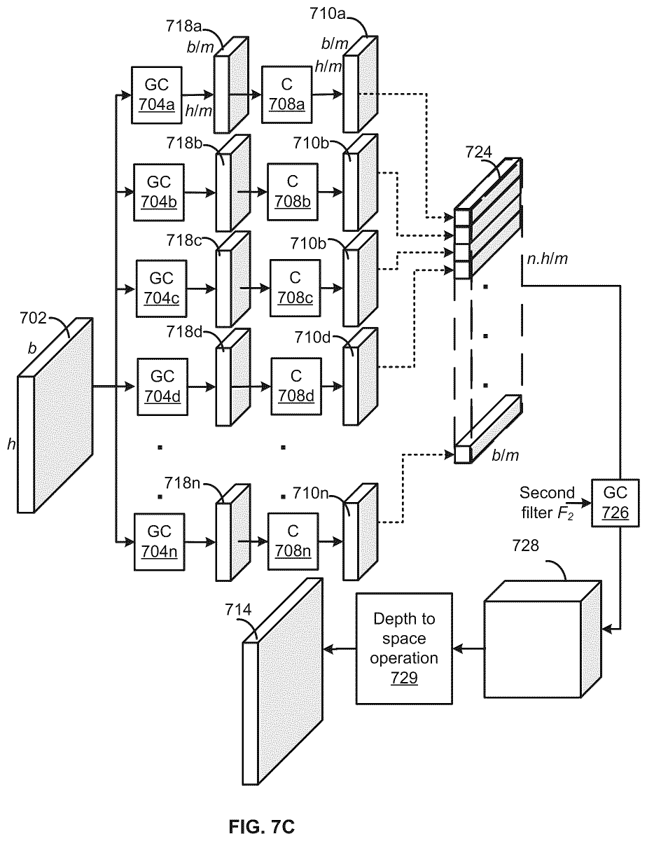

FIG. 7A illustrates an alternate method (704a-704n) of performing a convolution operation equivalent to the combination of the convolution operation (504, 604) described above with reference to FIGS. 5 and 6, with the first permutation (516, 616), producing a result 718 equivalent to the permuted first intermediate tensor (518, 618).

The method comprises receiving an input tensor 702. The input tensor 702 in FIG. 7A has a width (b) and height (h) and number of input channels Cᵢₙ. In FIG. 7A, the input tensor 702 is same as the input tensor 502 and 602 having three input channels i.e. Cᵢₙ=3.

In order to determine sandwich matrix product B^{T}dᵢB, instead of performing a direct convolution, in FIG. 7A, n separate grouped convolutions (GCs) 704a, 704b . . . 704n of the input tensor 702 are performed by convolving Cᵢₙ input channels of the input tensor with each one of the n kernels of the first filter F₁ separately to generate n separate first results 718a, 718b, . . . 718n each having Cᵢₙ channels. The first filter F₁ as described with reference to FIG. 5 has shape [Cᵢₙ, 4, 4, 1, 16]. This filter can be split on the final dimension into 16 filters (or, more generally, n filters, labelled Ka to Kn in FIG. 7A), each having shape [Cᵢₙ, 4, 4, 1, 1]. When all of the kernels among these 16 kernels are applied to the input tensor by performing 16 separate grouped convolutions, this gives 16 tensors 718 (or, more generally, n tensors 718), each having Cᵢₙ channels. The Cᵢₙ channels of each of the first results are not explicitly shown in FIG. 7A. Once we determine the n separate first results, these n first results are concatenated to obtain a permuted first intermediate tensor 718 having n groups of Cᵢₙ channels. The permuted first intermediate tensor 718 having n groups of Cᵢₙ channels obtained by concatenating the n first results is the same as the permuted first intermediate tensor (518 and 618) shown in FIG. 5 and FIG. 6.

In an example of 3×3 convolution the first filter F₁ is calculated based on the constant 4×4 matrix B comprises 16 kernels as explained with respect to FIGS. 4B, 5 and 6. The first filter comprises 16 kernels, where each kernel is a 4×4 matrix. As explained above, this filter F₁ can be split into a new tensor of shape [3, 4, 4, 1, 16] for use in the first grouped convolution 704. Hence instead of performing the first grouped convolution (504, 604) 16 grouped convolutions of 4×4×1×1 are performed across all three input channels of the input tensor to generate 16 first results 718a, 718b, . . . 718n, each having 3 channels.

Also, instead of performing the first channel permutation (516 or 616) for rearranging the 3 groups of 16 channels in the first intermediate tensor (506 or 606) into 16 groups of 3 channels (i.e. the permuted first intermediate tensor (518 or 618)), in FIG. 7A, the 16 first results 718a, 718b, . . . 718n (each having 3 channels) are concatenated into a first intermediate tensor 718 having 16 groups of 3 channels. Thus, the first intermediate tensor 718 having 16 groups of 3 channels obtained by concatenating the 16 first results is the same as the permuted first intermediate tensor 518 and the permuted first intermediate tensor 618 shown in FIG. 5 and FIG. 6.

The n separate first results 718a, 718b, . . . 718n each having Cᵢₙ channels may be concatenated, by writing each of the first results into the same first intermediate output tensor into appropriate locations in memory. Thus the step of performing concatenation can essentially be done without incurring costs such as additional computation or memory manipulation. However, this does require additional reads of the input tensor. Overall, the inventors have identified that this method performs significantly better on NNAs such as the example NNA described above than using an explicit permutation operation.

Furthermore, if the desired output is an output tensor having single output channel (514), the same process for generating the output tensor 514 from the permuted first intermediate tensor 518 can be performed on the first intermediate tensor 718. The steps of obtaining the output tensor having single output channel are the same as those described above with respect to FIG. 5. Alternatively, if the desired output is an output tensor having multiple output channels (614), the same process for generating the output tensor 614 from the permuted first intermediate tensor 618 can be performed on the first intermediate tensor 718. The steps of obtaining the output tensor having multiple output channel is same as that which is described above with respect to FIG. 6.

The inventors also identified that instead of performing a second grouped convolution on the permuted first intermediate tensor 718, in order to make the implementation of Winograd algorithm more efficient still on the example NNA, the second grouped convolution can be performed directly on the n first results. This avoids the need to immediately split the freshly concatenated first intermediate tensor 718 again into groups for processing by the grouped convolution (e.g. 608 in FIG. 6), thus reducing complexity and bandwidth.

FIG. 7B illustrates an alternate method of performing a convolution operation equivalent to the Hadamard product with cross-channel sum H. This method produces a second intermediate tensor 710 which is same as the second intermediate tensor 510 and 610 in FIG. 5 and FIG. 6.

The method comprises receiving an input tensor 702 and performing a convolution operation for determining a transformed input tensor equivalent to B^{T}dᵢB for all input tile data d across all input channels i.

In order to determine the sandwich matrix product B^{T}dᵢB, n separate grouped convolutions (GCs) 704a, 704b . . . 704n of the input tensor are performed as explained in FIG. 7A. These kernels are not shown in FIG. 7B for the sake of simplicity. Each of the n separate grouped convolutions 704a, 704b . . . 704n are performed by convolving all Cᵢₙ input channels of the input tensor with each of the n kernels of the first filter F₁ separately as described above with reference to FIG. 7A, to generate n separate first results 718a, 718b, . . . 718n, each having Cᵢₙ channels.

Once the n separate first results are determined, instead of performing concatenation as shown in FIG. 7A, another n separate grouped convolutions (GC) 708a, 708b . . . 708n) can be performed. That is, instead of performing concatenation of the n first results to obtain a permuted first intermediate tensor 718 having n groups of Cᵢₙ channels and then subsequently performing a second grouped convolution equivalent to determining the Hadamard product with cross-channel sum, another n separate convolutions 708a, 708b . . . 708n are performed directly on the n first results 718a, 718b, . . . 718n. Each of the n filters in the grouped weight tensor of shape [n, 1, 1, Cᵢₙ, Cₒᵤₜ] forms a partial weight tensor [1, 1, Cᵢₙ, Cₒᵤₜ] applied to the corresponding tensor 718a-n. Thus the n separate convolutions 708a, 708b . . . 708n are performed by convolving each first result with each of the n cross-channel filters of shape [1, 1, Cᵢₙ, Cₒᵤₜ] of the weight tensor separately to generate n separate second results 710a, 710b, . . . 710n, each having Cₒᵤₜ channels. Each of the n separate convolutions performed by applying one of the n filters of the weight tensor Wⱼᵢ on a corresponding first result is a dense 1×1×Cᵢₙ×Cₒᵤₜ convolution.

Once we determine the n separate second results 710a, 710b, . . . 710n, these n second results are concatenated to obtain a second intermediate tensor 710 having n groups of Cₒᵤₜ channels. Thus, the second intermediate tensor 710 having n groups of Cₒᵤₜ channels obtained by concatenating the n second results is same as the second intermediate tensor 610 shown in FIG. 6. In the example of 3×3 convolution shown in FIG. 6, the first and the second intermediate tensors each comprise 16 groups of 3 channels.

Furthermore, if the desired output is an output tensor having single output channel (514), the same steps of generating the output tensor 514 from the second intermediate tensor 510 can be performed on the second intermediate tensor 710. The steps of obtaining the output tensor having single output channel is same as that which is explained with respect to FIG. 5. Alternatively, if the desired output is an output tensor having multiple output channel (614), the same steps of generating the output tensor 614 from the second intermediate tensor 610 can be performed on the second intermediate tensor 710. The steps of obtaining the output tensor having multiple output channel is same as that which is explained with respect to FIG. 6.

Thus, once the second intermediate tensor 610 equivalent to the Hadamard product with cross-channel sum is determined, then a convolution transpose operation equivalent to the sandwich matrix product A^{T}HⱼA is performed to obtain an output tensor having multiple output channels. Now, in order to perform the step of convolution transpose efficiently, a channel permutation 620 to Cₒᵤₜ groups of n channels can be performed as explained above with respect to FIG. 6. Thus, once the channel permutation is performed, we would get the permuted second intermediate tensor having Cₒᵤₜ groups, each with a depth of n channels. The convolution transpose operation equivalent to the sandwich matrix product A^{T}HⱼA can then be performed.

In order to make the implementation of the Winograd algorithm more efficient still on hardware such as the example NNA, the inventors devised a method of also eliminating the second channel permutation (FIG. 7C). In order to eliminate the second channel permutation, instead of performing the channel concatenation as explained with respect to FIG. 7B, the second results 710a, 710b . . . 710n are interleaved on a spatial axis, for example the height axis, as shown in FIG. 7C. This interleaving may be performed by a strided write which interleaves the output on the height axis. This generates a third result 724 with a height of nh/2 and a width of b/2. In the example of 3×3 convolution, since the 16 second results 710a, 710b, etc each have 3 channels, the third result 724 would comprise 16 elements interleaved on the height axis, for a total height of 16h/2 and width of b/2.

Once the third result 724 is obtained, a following third grouped convolution 726 (N.B. this is referred to as a ‘third’ grouped convolution to distinguish from the previously labelled ‘first’ and ‘second’ grouped convolutions, even though in this example there are no ‘second’ grouped convolutions) is performed on the third result 724 using second filter F₂. This third grouped convolution 726 is equivalent to the sandwich matrix product A^{T} HA. The stride of the grouped convolution is chosen to be n in the dimension on which the interleaving has been performed. In the above examples of 3×3 convolutions, the stride of the third grouped convolution 726 would therefore be 16 on the height axis, and 1 on the width axis. Thus, the third grouped convolution 726 is a [Cₒᵤₜ, 16, 1, 1, 4] grouped convolution. The third grouped convolution produces a tensor 728 having n (16) groups of Cₒᵤₜ (3) channels, having a height h/2 and width b/2. Another option is to perform a sparse convolution, which would be significantly less efficient for the reasons described above with reference to the Hadamard product with cross-channel sum.

Finally, each group of 4 output channels in the tensor 728 is rearranged spatially using a depth to space operation 729, yielding the desired output tensor 714, which is identical to the output tensor 614.

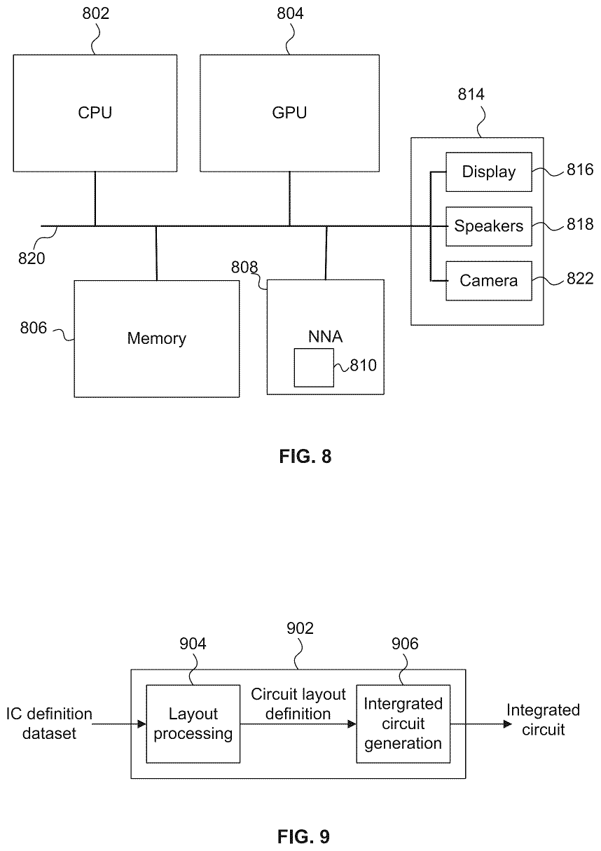

FIG. 8 shows a computer system in which the neural network systems described herein may be implemented. The computer system comprises a CPU 802, a GPU 804, a memory 806, a Neural Network Accelerator (NNA) 808 and other devices 814, such as a display 816, speakers 818 and a camera 822. A processing block 810 (which is representative of any of the various elements of the NNA 100 illustrated in FIG. 1B) is implemented on the NNA 808. The components of the computer system can communicate with each other via a communications bus 820.

The data processing system such as NNA or GPU having a plurality of convolution engines each having a plurality of layers, where at least one of the layers is configured to perform convolution of an input tensor with weights w based on a Winograd algorithm as shown in FIGS. 4-6 and 7A-7C. The data processing system may have a number of functional blocks. This is schematic only and is not intended to define a strict division between different logic elements of such entities. Each functional block may be provided in any suitable manner. It is to be understood that intermediate values described herein as being formed by a data processing system need not be physically generated by the data processing system at any point and may merely represent logical values which conveniently describe the processing performed by the data processing system between its input and output.

The data processing system described herein may be embodied in hardware on an integrated circuit. The data processing system described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a data processing system configured to perform any of the methods described herein, or to manufacture a data processing system comprising any apparatus described herein. An integrated circuit definition dataset may be, for example, an integrated circuit description.

Therefore, there may be provided a method of manufacturing, at an integrated circuit manufacturing system, a data processing system as described herein. Furthermore, there may be provided an integrated circuit definition dataset that, when processed in an integrated circuit manufacturing system, causes the method of manufacturing a data processing system to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a data processing system will now be described with respect to FIG. 9.

FIG. 9 shows an example of an integrated circuit (IC) manufacturing system 902 which is configured to manufacture a data processing system as described in any of the examples herein. In particular, the IC manufacturing system 902 comprises a layout processing system 904 and an integrated circuit generation system 906. The IC manufacturing system 902 is configured to receive an IC definition dataset (e.g. defining a data processing system as described in any of the examples herein), process the IC definition dataset, and generate an IC according to the IC definition dataset (e.g. which embodies a data processing system as described in any of the examples herein). The processing of the IC definition dataset configures the IC manufacturing system 902 to manufacture an integrated circuit embodying a data processing system as described in any of the examples herein.

The layout processing system 904 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 904 has determined the circuit layout it may output a circuit layout definition to the IC generation system 906. A circuit layout definition may be, for example, a circuit layout description.

The IC generation system 906 generates an IC according to the circuit layout definition, as is known in the art. For example, the IC generation system 906 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 902 may be implemented all in one location, e.g. by one party. Alternatively, the IC manufacturing system 902 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a data processing system without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 9 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 9, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A method of convolving an input tensor with weights w using hardware comprising a plurality of linear operation engines, the method being an adaptation of a Winograd algorithm, the Winograd algorithm splitting each input channel i of a total of Cᵢₙ input channels into one or more tiles dᵢ and calculating a result A[Σᵢ₌₁^{C}ᵢₙ(GwⱼᵢG^{T})∘(B^{T}dᵢB)]A^{T} for each output channel j, wherein G, B and A are constant matrices, the method comprising:
determining a first filter F₁ from matrix B wherein the filter F₁ comprises n kernels, each kernel being an outer product of two columns of the matrix B; and
using the linear operation engines to perform a convolution of the input tensor with the first filter F₁.

2. The method according to claim 1, wherein the convolution of the input tensor with the first filter F₁ is performed for determining a tensor equivalent to B^{T}dᵢB, for all tiles of all input channels i.

3. The method according to claim 1, wherein the convolution of the input tensor with the first filter F₁ includes performing a first grouped convolution of each input channel i of the input tensor with the n kernels of the first filter F₁ to generate a first intermediate tensor having Cᵢₙ groups of n channels, and wherein the method further comprises determining a tensor equivalent to Σᵢ₌₁^{C}ᵢₙ(GwⱼᵢG^{T})∘(B^{T}dᵢB) by using the linear operation engines to perform a second grouped convolution with a weight tensor W′, the weight tensor W′ being composed of partial weight tensors W′ji, where each W′ji is determined from constant matrix G and is equivalent to GwⱼᵢG^{T}.

4. The method according to claim 3,
wherein Cᵢₙ=1, and the second grouped convolution is a grouped convolution of the first intermediate tensor with the weight tensor W′; or
wherein:
Cᵢₙ≥2;
before performing the second grouped convolution, the method comprises permuting the channels of the first intermediate tensor to rearrange the Cᵢₙ groups of n channels into n groups of Cᵢₙ channels; and
the second grouped convolution is a grouped convolution of the n groups of Cᵢₙ channels with the weight tensor W′.

5. The method according to claim 4, wherein the second grouped convolution operation is performed by convolving each group of the first intermediate tensor with a corresponding part of the weight tensor W′ to generate a second intermediate tensor having n groups of Cₒᵤₜ channels.

6. The method according to claim 5, wherein the method further comprises determining a tensor equivalent to the result A[Σᵢ₌₁^{C}ᵢₙ(GwⱼᵢG^{T})∘(B^{T}dᵢB)]A^{T} for each output channel j by using the linear operation engines to perform convolution transpose using a second filter F₂ to generate an output tensor having Cₒᵤₜ channels.

7. The method according to claim 6,
wherein Cₒᵤₜ=1, and the convolution transpose is of the second intermediate tensor; or
wherein:
Cₒᵤₜ≥2;
before performing the convolution transpose, the method further comprises permuting the channels of the second intermediate tensor to rearrange the n groups of Cₒᵤₜ channels into Cₒᵤₜ groups of n channels; and
the convolution transpose is of the Cₒᵤₜ groups of n channels.

8. The method according to claim 6, wherein the second filter F₂ comprises a plurality of kernels, each kernel being an outer product of two columns of the matrix A.

9. The method according to claim 3, wherein the first grouped convolution is a stride m convolution to generate an (h/m)×(b/m) first intermediate tensor, where m is equal to the output tile size of the Winograd algorithm being adapted.

10. The method according to claim 1, wherein the convolution of the input tensor with the first filter F₁ includes performing n separate grouped convolutions of the Cᵢₙ input channels, each grouped convolution applying a corresponding kernel of the first filter F₁ to generate n separate first results, each having Cᵢₙ channels.

11. The method according to claim 10, wherein the method further comprises:
after performing the n separate grouped convolutions, concatenating the n first results to generate a first intermediate tensor having n groups of Cn channels,
determining Σᵢ₌₁^{C}ᵢₙ(GwⱼᵢG^{T})∘(BdᵢB^{T}) by using the linear operation engines, to perform a second grouped convolution by convolving each group of the first intermediate tensor having Cᵢₙ channels with a corresponding part of the weight tensor W′ to generate a second intermediate tensor having n groups of Cₒᵤₜ channels, where W′ is determined from constant matrix G and is equivalent to the matrices GwⱼᵢG^{T} for all output channels j and input channels i; and
permuting the channels of the second intermediate tensor having n groups of Cₒᵤₜ channels to generate Cₒᵤₜ groups of n channels; and
determining the result A[Σᵢ₌₁^{C}ᵢₙ(GwⱼᵢG^{T})∘(BdᵢB^{T})]A^{T} by using the linear operation engines to perform convolution transpose of the second intermediate tensor using the second filter F₂ to generate an output tensor having Cₒᵤₜ channels.

12. The method according to claim 10, wherein the method further comprises, after performing the n separate grouped convolutions to generate n separate first results, performing another n separate convolutions of each of the first results with a corresponding kernel of the weight tensor to generate n second results, each having Cₒᵤₜ channels.

13. The method according to claim 12, wherein after performing the another n separate convolutions, concatenating the n second results having Cₒᵤₜ channels to generate a second intermediate tensor having n groups of Cₒᵤₜ channels.

14. The method according to claim 13, wherein after performing concatenation, the method further comprises:
permuting the channels of the second intermediate tensor having n groups of Cₒᵤₜ channels to generate Cₒᵤₜ groups of n channels; and
determining the result A[Σ_{i=1,}^{C}ᵢₙ, (GwⱼᵢG^{T})∘(BdᵢB^{T})]A^{T} by using the linear operation engines to perform convolution transpose of the second intermediate tensor using the second filter F₂ to generate an output tensor having Cₒᵤₜ channels.

15. The method according to claim 12, wherein the method further comprises after performing the another n separate grouped convolutions to generate n second results, interleaving the second results on a spatial axis to generate a third result.

16. The method according to claim 15, wherein the method further comprises obtaining an output tensor having Cₒᵤₜ channels by performing a third grouped convolution followed by depth to space conversion.

17. A data processing system for implementing a neural network comprising a plurality of layers, wherein at least one of the layers is configured to perform an adaptation of a Winograd algorithm, the Winograd algorithm splitting each input channel i of a total of Cᵢₙ input channels into one or more tiles dᵢ and that calculates a result A[Σᵢ₌₁^{C}ᵢₙ(GwⱼᵢG^{T})∘(B^{T}dᵢB)]A^{T} convolution of an input tensor with weights w as part of an adaptation of a Winograd algorithm, the Winograd algorithm splitting each input channel i of a total of Cᵢₙ input channels into one or more tiles dᵢ and calculating a result A[Σᵢ₌₁^{C}ᵢₙ(GwⱼᵢG^{T})∘(B^{T}dᵢB)]A^{T} for each output channel j, wherein G, B and A are constant matrices, the data processing system comprising:
a neural network accelerator comprising a plurality of linear operation engines implemented in a fixed-function hardware circuitry, wherein the data processing system is configured to:
determine a first filter F₁ from matrix B wherein the filter F₁ comprises n kernels, each kernel being an outer product of two columns of the matrix B; and
using the linear operation engines, perform a convolution of the input tensor with the first filter F₁.

18. The data processing system of claim 17, wherein the data processing system further comprises a memory configured for storing a plurality of predetermined factors including the constant matrices G, B and A, a first filter based on matrix B, a second filter based on matrix A and a weight tensor W based on matrix G.

19. A data processing system for implementing a neural network configured to perform the method as set forth in claim 1.

20. A non-transitory computer readable storage medium having stored thereon computer readable code configured to cause the method as set forth in claim 1 to be performed when the code is run.
